(19) United States
(12) Patent Application Publication
(10) Pub. No.: US 2026/0247294 A1
(43) Pub. Date: Aug. 20, 2026

(54) CLOSED LOOP POWER CONTROL ENHANCEMENTS FOR SINGLE DOWNLINK CONTROL INFORMATION BASED SIMULTANEOUS PHYSICAL UPLINK SHARED CHANNEL TRANSMISSIONS

(71) Applicant: APPLE INC., Cupertino, CA (US)

(72) Inventors: Haitong Sun, Cupertino, CA (US); Seyed Ali Akbar Fakoorian, San Diego, CA (US); Dawei Zhang, Saratoga, CA (US); Wei Zeng, San Diego, CA (US); Chunxuan Ye, San Diego, CA (US)

(21) Appl. No.: 19/160,610

(22) PCT Filed: Mar. 22, 2024
(86) PCT No.: PCT/US2024/021058

§ 371 Date: Aug. 28, 2025

Related U.S. Application Data
(60) Provisional application No. 63/493,398, filed on Mar. 31, 2023.

(51) Int. Cl. H04W 52/14; H04W 72/1268; H04W 72/232

(52) U.S. Cl. CPC H04W 52/146; H04W 72/1268; H04W 72/232

(57) ABSTRACT

Power control enhancements for cases using a single downlink control information (DCI) to schedule simultaneous physical uplink shared channels (PUSCHs) sent on separate antenna panels of a user equipment (UE) are discussed herein. In some embodiments, a DCI includes one or more sounding reference signal (SRS) resource indicators (SRIs) that are applied with respect to one or more SRI-indexed power control lists for the antenna panels to determine an open loop transmit power factor for each of two simultaneous PUSCHs. In some embodiments, a DCI includes one or more transmit power control (TPC) commands that are applied with respect to stored closed loop transmit power factors for the antenna panels to determine a closed loop transmit power factor for each of two simultaneous PUSCHs. Dynamic point selection (DPS) use in these contexts is also discussed. Power scaling for simultaneous PUSCHs is also discussed.

### TECHNICAL FIELD

This application relates generally to wireless communication systems, including wireless communication systems implementing single-DCI-based simultaneous PUSCH transmissions.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram showing various options for performing power scaling for simultaneous PUSCH transmissions, according to embodiments herein.

FIG. 2 illustrates a method of a UE having a first antenna panel and a second antenna panel, according to embodiments herein.

FIG. 3 illustrates a method of a RAN, according to embodiments herein.

FIG. 4 illustrates a method of a UE having a first antenna panel and a second antenna panel, according to embodiments herein.

FIG. 5 illustrates a method of a UE having a first antenna panel and a second antenna panel, according to embodiments herein.

FIG. 6 illustrates a method of a RAN, according to embodiments herein.

FIG. 7 illustrates a method of a UE having a first antenna panel and a second antenna panel, according to embodiments herein.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In some wireless communication systems, for sounding reference signal (SRS) power control, a power control parameter set is configured in an SRS-ResourceSet information element (IE). This power control parameter set may include, for example: an alpha parameter used for partial and/or full pathloss compensation; a Po parameter providing a target receive (Rx) power at a receiver of a base station; and/or a pathlossReferenceRS parameter identifying the reference signal that is used for a pathloss estimate. Furthermore, in such cases, a closed loop power control transmit power control (TPC) command may be indicated by a downlink control information (DCI) (e.g., a DCI format 2_3 in some wireless communication systems).

Further, in some wireless communication systems, physical uplink shared channel (PUSCH) power control information is indicated by an SRS resource indicator (SRI). An SRI may be provided to a UE in an “SRS resource indicator” field in DCI.

The UE may be separately (e.g., previously) configured with a PUSCH-PowerControl IE having one or multiple SRI-PUSCH-PowerControl IEs listed therein, with each SRI-PUSCH-PowerControl IE mapped to one possible SRI that may identified in an SRI provided in the DCI. An SRI-PUSCH-PowerControl IE may include, for example: an alpha parameter used for partial and/or full pathloss compensation; a P₀ parameter providing a target Rx power at a receiver of a base station; a pathlossReferenceRS parameter identifying the reference signal that is used for a pathloss estimate; and/or a ClosedLoopIndex index for closed loop power control (e.g., either 0 or 1) that identifies a stored closed loop transmit power factor in a memory of the UE. Furthermore, in such cases, a closed loop power control TPC command may be indicated by a DCI (e.g., a DCI format 0_1, 0_2, or 2_2, in some wireless communication systems).

A listing of one or multiple SRI-PUSCH-PowerControl IEs is an example of an “SRI-indexed power control list” as discussed herein.

It has been determined that at least some wireless communication systems may be benefitted through the support and use of single-DCI-based simultaneous PUSCH transmissions, where a single DCI schedules the use of multiple (e.g., two) simultaneous PUSCH transmissions by the UE. In some cases, such single-DCI-based simultaneous PUSCH transmissions may be sent by the UE according to spatial division multiplexing (SDM). For example, this may correspond to one of multiple beneficial various schemes for simultaneous transmission across multi-panel (STxMP) PUSCH transmission in a single-DCI based multiple transmission reception point (TRP) (mTRP) system in some wireless communication systems (where such various schemes may include the SDM-based transmission scheme, an single frequency network (SFN)-based transmission scheme that is supported, for example, in addition to the SDM-based transmission scheme, etc.).

It may be that when performing simultaneous PUSCH transmissions, a UE uses multiple antenna panels. In some cases, each one of the antenna panels transmits one of the simultaneous PUSCH transmissions. For example, it may be that a first antenna panel of the UE is used to transmit a first of two simultaneous PUSCH transmissions, while a second antenna panel of the UE is used to transmit the second of the two simultaneous PUSCH transmissions.

It will be understood that different antenna panels of a UE may observe different physical channels/different pathlosses on their respective physical channels (e.g., because of channel differences due to differing locations and/or orientations on/in/with respect to the UE for each of the antenna panels, due to the use of directed communications with different TRPs at each of the antenna panels, due to different power levels used at each of the antenna panels, etc.). To account for such differences as between the multiple antenna panels of the UE, it may be beneficial to implement one or more the power control enhancements at the UE that operate on a per-antenna-panel basis.

Herein, power control enhancements for a single-DCI-based simultaneous PUSCH transmission context are proposed. First, open loop power control (OLPC) enhancements for PUSCH power control in the single-DCI-based simultaneous PUSCH transmission context are discussed. Then, closed loop power control (CLPC) enhancements for PUSCH power control in the single-DCI-based simultaneous PUSCH transmission context are discussed. Finally, PUSCH power scaling enhancements for the single-DCI-based simultaneous PUSCH transmission context are discussed.

### OLPC PUSCH Power Control Enhancements

OLPC PUSCH embodiments herein may relate to the determination of open loop transmit power factors used by UEs when determining transmit powers to use for corresponding PUSCHs.

In a first option for an applicable OLPC PUSCH power control configuration with respect to single-DCI-based simultaneous PUSCH transmissions, there may be a single PUSCH-PowerControl IE in a PUSCH-Config IE configured at the UE by the network. Within the PUSCH-PowerControl IE, there may be a single list of one or more SRI-PUSCH-PowerControl IEs (e.g., a single SRI-indexed power control list). Under the first option, the UE may apply the same list of one or more SRI-PUSCH-PowerControl IEs with respect to transmissions on each of two antenna panels.

With respect to each of the simultaneous PUSCH transmissions, this process may include, for example, applying a first SRI for the first antenna panel from a DCI that schedules the simultaneous PUSCH transmissions with the list of one or more SRI-PUSCH-PowerControl IEs to determine a first open loop transmit power factor for a first PUSCH on the first antenna panel and applying a second SRI for the second antenna panel from the DCI that schedules the simultaneous PUSCH transmissions with the (same) list of one or more SRI-PUSCH-PowerControl IEs to determine a second open loop transmit power factor for a second PUSCH on the second antenna panel. Note that in some cases, the first SRI for the first antenna panel from the DCI and the second SRI for the second antenna panel from the DCI may be the same SRI as given in the DCI, while in other cases these may be two independent SRIs each provided in the DCI for an individual antenna panel.

In a second option for an applicable OLPC PUSCH power control configuration with respect to single-DCI-based simultaneous PUSCH transmissions, there may be a single PUSCH-PowerControl IE in a PUSCH-Config IE configured at the UE by the network. Within the PUSCH-PowerControl IE, there may be multiple lists of one or more SRI-PUSCH-PowerControl IEs (e.g., multiple SRI-indexed power control lists). Under the second option, the UE may apply the first list of one or more SRI-PUSCH-PowerControl IEs with respect to transmissions on a first antenna panel and the second list of one or more SRI-PUSCH-PowerControl IEs with respect to transmissions on a second antenna panel.

With respect to each of the simultaneous PUSCH transmissions, this process may include, for example, applying a first SRI for the first antenna panel from a DCI that schedules the simultaneous PUSCH transmissions with the first list of one or more SRI-PUSCH-PowerControl IEs to determine a first open loop transmit power factor for a first PUSCH on the first antenna panel and applying a second SRI for the second antenna panel from the DCI that schedules the simultaneous PUSCH transmissions with the second list of one or more SRI-PUSCH-PowerControl IEs to determine a second open loop transmit power factor for a second PUSCH on the second antenna panel. Note that in some cases, the first SRI for the first antenna panel from the DCI and the second SRI for the second antenna panel from the DCI may be the same SRI as given in the DCI, while in other cases these may be two independent SRIs each provided in the DCI for an individual antenna panel.

In a third option for an applicable OLPC PUSCH power control configuration with respect to single-DCI-based simultaneous PUSCH transmissions, there may be two PUSCH-PowerControl IEs in a PUSCH-Config IE configured at the UE by the network. Within each of the two PUSCH-PowerControl IE, there may be a list of one or more SRI-PUSCH-PowerControl IEs (e.g., an SRI-indexed power control list may be found in each PUSCH-PowerControl IE). Under the third option, the UE may apply the first list of one or more SRI-PUSCH-PowerControl IEs from the first PUSCH-PowerControl IE with respect to transmissions on a first antenna panel and the second list of one or more SRI-PUSCH-PowerControl IEs from the second PUSCH-PowerControl IE with respect to transmissions on a second antenna panel.

With respect to each of the simultaneous PUSCH transmissions, this may process may include, for example, applying a first SRI for the first antenna panel from a DCI that schedules the simultaneous PUSCH transmissions with the first list of one or more SRI-PUSCH-PowerControl IEs from the first PUSCH-PowerControl IE to determine a first open loop transmit power factor for a first PUSCH on the first antenna panel and applying a second SRI for the second antenna panel from the DCI that schedules the simultaneous PUSCH transmissions with the second list of one or more SRI-PUSCH-PowerControl IEs from the second PUSCH-PowerControl IE to determine a second open loop transmit power factor for a second PUSCH on the second antenna panel. Note that in some cases, the first SRI for the first antenna panel from the DCI and the second SRI for the second antenna panel from the DCI may be the same SRI as given in the DCI, while in other cases these may be two independent SRIs each provided in the DCI for an individual antenna panel.

When utilizing OLPC for single-DCI-based simultaneous PUSCH transmissions, the single DCI (which may be, for example, of format 0_1 and/or 0_2) may provide one or more SRIs in one or more SRI fields. In some cases, a single SRI field providing a single SRI may be present in the DCI. In such cases, that same SRI may be applied to one or more lists of one or more SRI-PUSCH-PowerControl IEs (e.g., one or more SRI-indexed power control lists) that correspond to the first antenna panel and/or the second antenna panel. Note that in some such cases, a single such list of SRI-PUSCH-PowerControl IEs may exist that is used with respect to each of the antenna panels for determining an open loop transmit power factor for each PUSCH on each antenna panel, while in other such cases there may be two independent such lists of SRI-PUSCH-PowerControl IEs, each used with respect to an individual antenna panel to determine an open loop transmit power factor for the PUSCH on that antenna panel.

In other cases, there may be two SRIs provided in two SRI fields of the single DCI. In such cases, the first SRI may indicate into a list of one or more SRI-PUSCH-PowerControl IEs (e.g., an SRI-indexed power control list) that corresponds to the first antenna panel, while the second SRI may indicate into a list of SRI-PUSCH-PowerControl IEs (e.g., an SRI-indexed power control list) that corresponds to the second antenna panel. Note that in some such cases, a single such list of SRI-PUSCH-PowerControl IEs may exist that is used with respect to each of the antenna panels for determining an open loop transmit power factor for each PUSCH on each antenna panel, while in other such cases there may be two independent such lists of SRI-PUSCH-PowerControl IEs, each used with respect to an individual antenna panel to determine an open loop transmit power factor for the PUSCH on that antenna panel.

In wireless communication systems configured for single-DCI-based simultaneous PUSCH transmissions, when the single DCI (which may be, for example, of format 0_1 and/or 0_2) includes two SRI fields each having an independent SRI, there are various implementations in the case that dynamic point selection (DPS), where the network schedules the UE to transmit a PUSCH from only one antenna panel, is used.

In a first option, the SRI in the single DCI that corresponds to (that is for) the scheduled antenna panel may be used, and the other SRI is reserved. For example, if the single DCI schedules the UE to transmit the PUSCH from the first antenna panel, a first SRI of the two SRIs that is for the first antenna panel (e.g., based on the order of the two SRIs in the DCI) may be applied to a list of one or more SRI-PUSCH-PowerControl IEs that is for the first antenna panel to determine an open loop transmit power factor for the PUSCH. Further, if instead the single DCI schedules the UE to transmit the PUSCH from the second antenna panel, a second SRI of the two SRIs that is for the second antenna panel (e.g., based on the order of the two SRIs in the single DCI) may be applied to a list of one or more SRI-PUSCH-PowerControl IEs that is for the second antenna panel to determine an open loop transmit power factor for the PUSCH.

In a second option, the first-ordered SRI in the single DCI (based on the order of the two SRIs in the DCI) is used in every case, and the second-ordered SRI (based on the order of the two SRIs in the DCI) is reserved. For example, if the single DCI schedules the UE to transmit the PUSCH from the first antenna panel, the first-ordered SRI (based on the order of the two SRIs in the DCI) may be applied to a list of one or more SRI-PUSCH-PowerControl IEs that is for the first antenna panel to determine an open loop transmit power factor for the PUSCH. Further, if instead the single DCI schedules the UE to transmit the PUSCH from the second antenna panel, the first-ordered SRI (based on the order of the two SRIs in the single DCI) may be applied to a list of one or more SRI-PUSCH-PowerControl IEs that is for the second antenna panel to determine an open loop transmit power factor for the PUSCH.

Note that under either option, the two antenna panels may be mapped to different SRS-ResourceSets or to different SRS-Resources. In other words, it may be that an SRI in the DCI used with the first antenna panel may index into a first SRS-ResourceSet for the first antenna panel, and/or an SRI in the DCI used with the second antenna panel may index into a second SRS-ResourceSet for the second antenna panel. Alternatively, an SRI in a DCI used with the first antenna panel may index into a first group of SRS-Resources in a (single) SRS-ResourceSet for the first antenna panel, and/or an SRI in the DCI used with the second antenna panel may index into a second group of SRS-Resources in the (single) SRS-ResourceSet for the second antenna panel.

In some wireless communication systems using OLPC for single-DCI-based simultaneous PUSCH transmissions, it may be that the system is configured to cause each of the simultaneous PUSCHs to be transmitted according to a same open loop transmit power factor. In such systems, a first SRI/list of one or more SRI-PUSCH-PowerControl IEs pair may be used to determine a first open loop transmit power factor P₀, while a second SRI/list of one or more SRI-PUSCH-PowerControl IEs pair may be used determine a second open loop transmit power factor P₁ (e.g., in the manner described elsewhere herein). Then, in a first option, an open loop transmit power factor for each of the simultaneous PUSCHs is determined to be max {P₀, P₁}. In a second option, an open loop transmit power factor for each of the simultaneous PUSCHs is determined to be min{P₀, P₁}.

In other cases, each of the simultaneous PUSCHs may be transmitted according to the individual open loop transmit power factor P₀, P₁ individually determined with respect to the SRI/list of one or more SRI-PUSCH-PowerControl IEs pair corresponding to the antenna panel for that PUSCH. This results in, for example, a first PUSCH being transmitted according to the first open loop transmit power factor P₀, while a second PUSCH is transmitted according to the second open loop transmit power factor P₁, where P₀ and P₁ may (or may not) be different values.

### CLPC PUSCH Power Control Enhancements

CLPC PUSCH embodiments herein may relate to the determination of closed loop transmit power factors used by UEs when determining transmit powers to use for corresponding PUSCHs.

In embodiments for CLPC PUSCH power control configurations with respect to single-DCI-based simultaneous PUSCHs on corresponding antenna panels, it may be that two simultaneously transmitted PUSCHs may be configured/indicated with respect to different closed loop indexes (e.g., with one corresponding to index “0” and the other corresponding to index “1”). These closed loop indexes may correspond respectively to a first stored closed loop transmit power factor for a first antenna panel of the UE and a second stored closed loop transmit power factor for a second antenna panel of the UE.

For CLPC, when the UE is operating in an accumulation mode, the first stored closed loop transmit power factor and/or the second stored closed loop transmit power factor are updated based on incoming TPC(s) according to the accumulation mode. When the UE is operating outside of the accumulation mode, the first stored closed loop transmit power factor and/or the second stored closed loop transmit power factor are replaced based on incoming TPC(s) according to the non-accumulation mode.

When utilizing CLPC for single-DCI-based simultaneous PUSCH transmissions, a DCI (which may be, for example, of format 0_1, 0_2, or 2_2) may provide one or more TPC commands in one or more TPC fields. Note that in some cases, the DCI having the one or more TPC commands may be a (single) DCI that schedules the simultaneous PUSCHs. In other cases, the DCI having the one or more TPC commands may be a separate (e.g., later) DCI to the DCI that schedules the simultaneous PUSCHs.

In some cases, a single TPC field providing a single TPC command may be present in the DCI. In such cases, that same TPC command may be applied to (e.g., used to update or replace) each of the first stored closed loop transmit power factor and the second stored closed loop transmit power factor at the UE.

In other cases, a DCI may include multiple TPC fields, each providing independent TPC commands. In such cases, a first TPC command may be applied to (e.g., used to update or replace) the first stored closed loop transmit power factor at the UE and a second TPC command may be applied to (e.g., used to update or replace) the second stored closed loop transmit power factor at the UE.

It is noted that the first antenna panel may be associated with an SRI that indicates into a first list of one or more SRI-PUSCH-PowerControl IEs that is for the first antenna panel, and that the second antenna panel may be associated with an SRI that indicates into a list of one or more SRI-PUSCH-PowerControl IEs that is for the second antenna panel (e.g., in the manner described elsewhere herein).

In wireless communication systems configured for single-DCI-based simultaneous PUSCH transmissions, when a DCI (which may be of, for example, format 0_1 and/or 0_2) includes two TPC fields each having an independent TPC command, there are various implementations in the case that DPS, where the network schedules the UE to transmit a PUSCH from only one antenna panel, is used.

In a first option, the TPC command in the DCI that corresponds to (that is for) the scheduled antenna panel may be used, and the other TPC is reserved. For example, if the DCI schedules the UE to transmit the PUSCH from the first antenna panel, a first TPC command of the two TPC commands that is for the first antenna panel (e.g., based on the order of the two TPC commands in the DCI) may be applied to (e.g., used to update or replace) a first stored closed loop transmit power factor at the UE corresponding to the first antenna panel. Further, if instead the DCI schedules the UE to transmit the PUSCH from the second antenna panel, a second TPC command of the two TPC commands that is for the second antenna panel (e.g., based on the order of the two TPC commands in the DCI) may be applied to (e.g., used to update or replace) a second stored closed loop transmit power factor at the UE corresponding to the second antenna panel.

In a second option, the first-ordered TPC command in the DCI (based on the order of the two TPC commands in the DCI) is used in every case, and the second-ordered TPC command (based on the order of the two TPC commands in the DCI) is reserved. For example, if the DCI schedules the UE to transmit the PUSCH from the first antenna panel, the first-ordered TPC command (based on the order of the two TPC commands in the DCI) may be applied to (e.g., used to update or replace) a first stored closed loop transmit power factor at the UE corresponding to the first antenna panel (e.g., that is used in conjunction with the use of an SRI that indicates into a list of one or more SRI-PUSCH-PowerControl IEs with respect to the first panel). Further, if instead the DCI schedules the UE to transmit the PUSCH from the second antenna panel, the first-ordered TPC command (based on the order of the two TPC commands in the single DCI) may be applied to (e.g., used to update or replace) a second stored closed loop transmit power factor at the UE corresponding to the second antenna panel (e.g., that is used in conjunction with the use of an SRI that indicates into a list of one or more SRI-PUSCH-PowerControl IEs with respect to the second antenna panel).

When utilizing CLPC for single-DCI-based simultaneous PUSCH transmissions, it may be that the DCI having the TPC commands (e.g., of format 0_1, 0_2, and/or 2_2) omits the use of a closed loop indicator. Further, it may be that one or more of the TPC commands in the TPC fields is represented by 2 bits. When using two TPC commands, it may be that a first of the TPC commands corresponds to the closed loop index of 0, while the second TPC command corresponds to the closed loop index of 1.

### PUSCH Power Scaling Enhancements

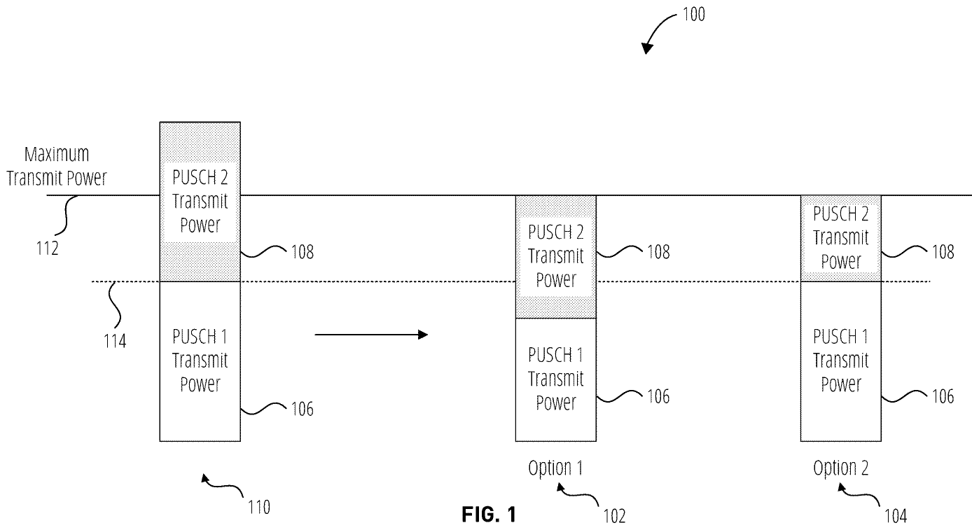

FIG. 1 illustrates a diagram 100 showing various options 102, 104 for performing power scaling for simultaneous PUSCH transmissions, according to embodiments herein. The diagram 100 first illustrates a non-scaled scenario 110 showing a first PUSCH transmit power 106 and a second PUSCH transmit power 108 for two PUSCHs that are transmitted simultaneously (e.g., on separate corresponding antenna panels, as discussed herein). As illustrated, the non-scaled scenario 110 exceeds a maximum transmit power limit 112 allowed at the UE (e.g., where the maximum transmit power limit 112 corresponds to a UE capability and/or a UE configuration). Note also that FIG. 1 illustrates a reference line 114 that is provided with respect to the boundary between the first PUSCH transmit power 106 and the second PUSCH transmit power 108 in the non-scaled scenario 110 to facilitate understanding of the options 102 and 104, which will now be discussed.

In the first option 102 (labelled “Option 1” in FIG. 1), the UE may reduce the both the first PUSCH transmit power 106 and the second PUSCH transmit power 108 such that the sum of these is within the maximum transmit power limit 112, as illustrated.

Under the first option 102 (where both PUSCH transmit powers are reduced), there may be a variety of options for performing the reductions of each PUSCH transmit power. In a first case, each PUSCH transmit power may be reduced by a same percentage until the maximum transmit power limit is met. This case may correspond to, for example, the reduction of each of the PUSCH transmit powers by a same decibel (dB) amount until the maximum transmit power limit is met.

In another case, each of the PUSCH's transmit powers may be reduced by a same absolute amount of transmit power until the maximum transmit power limit is met.

In the second option 104 (labelled “Option 2” in FIG. 1), the UE may reduce one of the first PUSCH transmit power 106 and the second PUSCH transmit power 108 prior to any reduction of the other of the first PUSCH transmit power 106 and the second PUSCH transmit power 108. As can be seen, the second option 104 illustrates specifically the case where the second PUSCH transmit power 108 has been adjusted first (while the first PUSCH transmit power 106 remains unadjusted).

Accordingly, for simultaneous PUSCH transmissions, corresponding to disclosure herein, it may be understood that there are cases where the transmit power of each of the PUSCHs may be different, and cases where the transmit power of each of the PUSCHs may be the same.

In some embodiments of PUSCH transmit power scaling for simultaneous PUSCH transmissions, a value X dB may be considered for scaling purposes. Then, in a first option, a first PUSCH may first have its transmit power reduced by up to X dB. However, if the value of the reduction to the first PUSCH needed to bring the total transmit power of both PUSCHs within the maximum transmit power limit is greater than X dB, then the first PUSCH may be dropped (and, e.g., the second PUSCH may be sent alone). This dropping may be because, for example, it has been determined that a transmission of the first PUSCH that has been reduced by more than X dB is not likely to be successfully received.

In a second option, a first PUSCH may first have its transmit power reduced by up to X dB. Once the value of X dB is reduced at the first PUSCH, the second PUSCH may then begin to have its transmit power reduced until the total transmit power of both PUSCHs is within the applicable maximum transmit power limit. This splitting of the reduction across both PUSCHs may prevent the first PUSCH from dropping below a power level that is not likely to be successfully received.

Note that under any of these options, the value of X may be configured to the UE by the network (e.g., based on network congestion levels and/or UE capabilities known at the network).

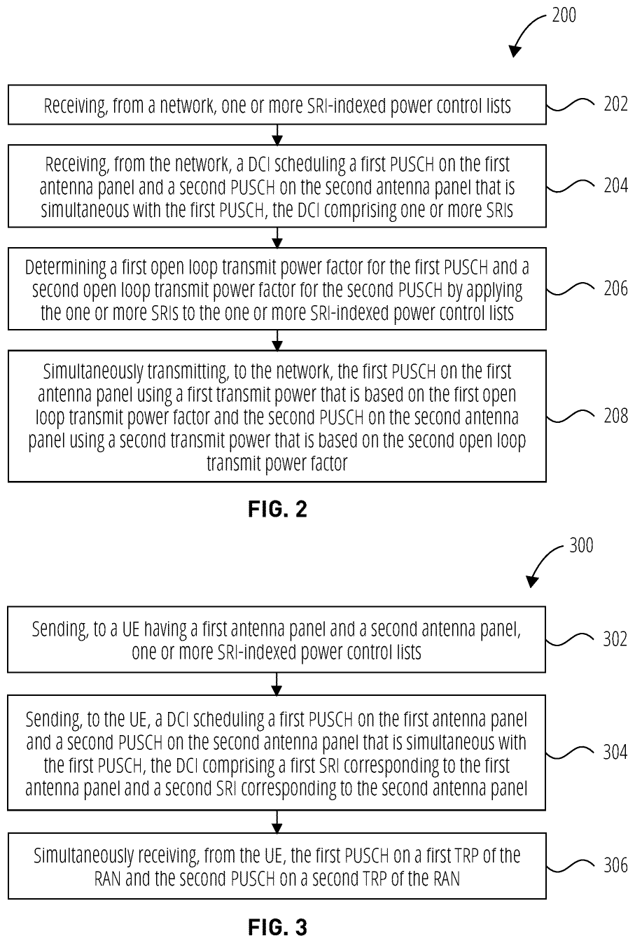

FIG. 2 illustrates a method 200 of a UE having a first antenna panel and a second antenna panel, according to embodiments herein. The method 200 includes receiving 202, from a network, one or more SRI-indexed power control lists. The method 200 further includes receiving 204, from the network, a DCI scheduling a first PUSCH on the first antenna panel and a second PUSCH on the second antenna panel that is simultaneous with the first PUSCH, the DCI comprising one or more SRIs. The method 200 further includes determining 206 a first open loop transmit power factor for the first PUSCH and a second open loop transmit power factor for the second PUSCH by applying the one or more SRIs to the one or more SRI-indexed power control lists. The method 200 further includes simultaneously transmitting 208, to the network, the first PUSCH on the first antenna panel using a first transmit power that is based on the first open loop transmit power factor and the second PUSCH on the second antenna panel using a second transmit power that is based on the second open loop transmit power factor.

In some embodiments of the method 200, the one or more SRI-indexed power control lists comprises a first SRI-indexed power control list corresponding to the first antenna panel and a second SRI-indexed power control list corresponding to the second antenna panel, the one or more SRIs comprises a first SRI that corresponds to each of the first antenna panel and the second antenna panel, and the applying the one or more SRIs to the one or more SRI-indexed power control lists comprises applying the first SRI to each of the first SRI-indexed power control list and the second SRI-indexed power control list.

In some embodiments of the method 200, the one or more SRI-indexed power control lists comprises a first SRI-indexed power control list corresponding to the first antenna panel and a second SRI-indexed power control list corresponding to the second antenna panel, the one or more SRIs comprises a first SRI corresponding to the first antenna panel and a second SRI corresponding to the second antenna panel, and the applying the one or more SRIs to the one or more SRI-indexed power control lists comprises applying the first SRI to the first SRI-indexed power control list and the second SRI to the second SRI-indexed power control list.

In some embodiments of the method 200, the one or more SRI-indexed power control lists comprises a first SRI-indexed power control list corresponding to each of the first antenna panel and the second antenna panel, the one or more SRIs comprises a first SRI corresponding to the first antenna panel and a second SRI corresponding to the second antenna panel, and the applying the one or more SRIs to the one or more SRI-indexed power control lists comprises applying the first SRI to the first SRI-indexed power control list.

In some embodiments of the method 200, the one or more SRI-indexed power control lists comprises a first SRI-indexed power control list corresponding to each of the first antenna panel and the second antenna panel, the one or more SRIs comprises a first SRI corresponding to the first antenna panel and a second SRI corresponding to the second antenna panel, and the applying the one or more SRIs to the one or more SRI-indexed power control lists comprises applying each of the first SRI and the second SRI to the first SRI-indexed power control list.

In some embodiments, the method 200 further includes identifying a minimum open loop transmit power factor resulting from the applying the one or more SRIs to the one or more SRI-indexed power control lists, and determining the first open loop transmit power factor for the first PUSCH and the second open loop transmit power factor for the second PUSCH comprises setting each of the first open loop transmit power factor and the second open loop transmit power factor to the minimum open loop transmit power factor.

In some embodiments, the method 200 further includes identifying a maximum open loop transmit power factor resulting from the applying the one or more SRIs to the one or more SRI-indexed power control lists, and determining the first open loop transmit power factor for the first PUSCH and the second open loop transmit power factor for the second PUSCH comprises setting each of the first open loop transmit power factor and the second open loop transmit power factor to the maximum open loop transmit power factor.

In some embodiments of the method 200, the first open loop transmit power factor is different from the second open loop transmit power factor.

In some embodiments of the method 200, each of the first transmit power and the second transmit power are further based on a scaling percentage determined with respect to a maximum transmit power for the UE.

In some embodiments of the method 200, each of the first transmit power and the second transmit power are further based on a scaling amount determined with respect to a maximum transmit power for the UE.

In some embodiments of the method 200, the first transmit power is further based on a scaling determined with respect to a maximum transmit power for the UE and the second transmit power.

In some embodiments of the method 200, the first transmit power is further based on a first scaling percentage determined with respect to a maximum transmit power for the UE, and the second transmit power is further based on a second scaling percentage determined with respect to a maximum transmit power for the UE and the first scaling percentage.

FIG. 3 illustrates a method 300 of a RAN, according to embodiments herein. The method 300 includes sending 302, to a UE having a first antenna panel and a second antenna panel, one or more SRI-indexed power control lists. The method 300 further includes sending 304, to the UE, a DCI scheduling a first PUSCH on the first antenna panel and a second PUSCH on the second antenna panel that is simultaneous with the first PUSCH, the DCI comprising a first SRI corresponding to the first antenna panel and a second SRI corresponding to the second antenna panel. The method 300 further includes simultaneously receiving 306, from the UE, the first PUSCH on a first TRP of the RAN and the second PUSCH on a second TRP of the RAN.

In some embodiments of the method 300, the one or more SRI-indexed power control lists comprises a first SRI-indexed power control list corresponding to each of the first antenna panel and the second antenna panel.

In some embodiments of the method 300, the one or more SRI-indexed power control lists comprises a first SRI-indexed power control list corresponding to the first antenna panel and a second SRI-indexed power control list corresponding to the second antenna panel.

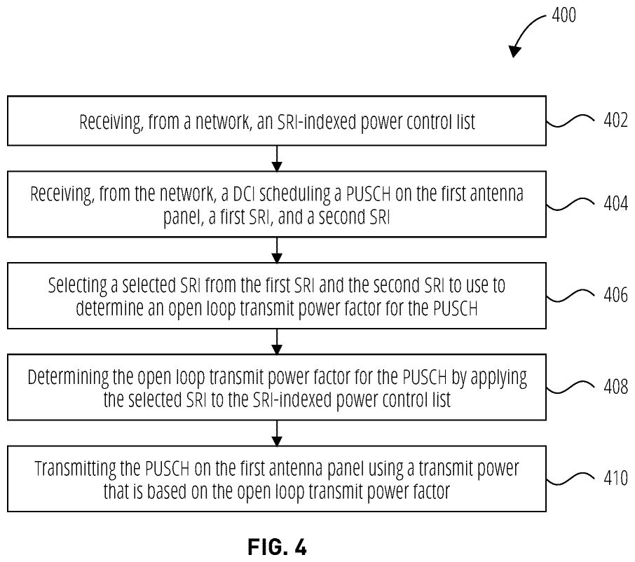

FIG. 4 illustrates a method 400 of a UE having a first antenna panel and a second antenna panel, according to embodiments herein. The method 400 includes receiving 402, from a network, a SRI-indexed power control list. The method 400 further includes receiving 404, from the network, a DCI scheduling a PUSCH on the first antenna panel, a first SRI, and a second SRI. The method 400 further includes selecting 406 a selected SRI from the first SRI and the second SRI to use to determine an open loop transmit power factor for the PUSCH. The method 400 further includes determining 408 the open loop transmit power factor for the PUSCH by applying the selected SRI to the SRI-indexed power control list. The method 400 further includes transmitting 410 the PUSCH on the first antenna panel using a transmit power that is based on the open loop transmit power factor.

In some embodiments of the method 400, the selected SRI is selected based on a correspondence of the selected SRI to the first antenna panel.

In some embodiments of the method 400, the selected SRI is a first-ordered SRI of the first SRI and the second SRI in the DCI.

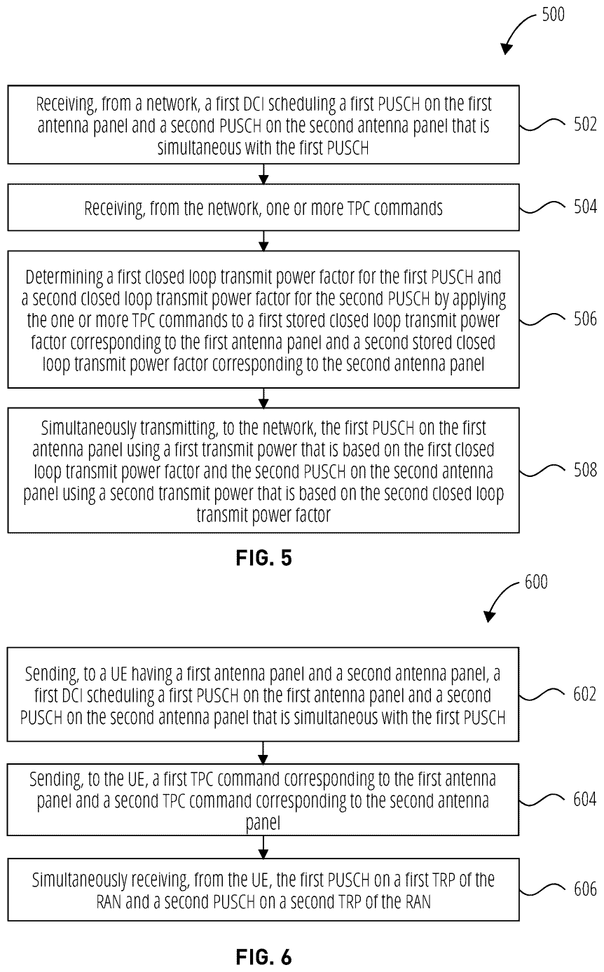

FIG. 5 illustrates a method 500 of a UE having a first antenna panel and a second antenna panel, according to embodiments herein. The method 500 includes receiving 502, from a network, a first DCI scheduling a first PUSCH on the first antenna panel and a second PUSCH on the second antenna panel that is simultaneous with the first PUSCH. The method 500 further includes receiving 504, from the network, one or more TPC commands. The method 500 further includes determining 506 a first closed loop transmit power factor for the first PUSCH and a second closed loop transmit power factor for the second PUSCH by applying the one or more TPC commands to a first stored closed loop transmit power factor corresponding to the first antenna panel and a second stored closed loop transmit power factor corresponding to the second antenna panel. The method 500 further includes simultaneously transmitting 508, to the network, the first PUSCH on the first antenna panel using a first transmit power that is based on the first closed loop transmit power factor and the second PUSCH on the second antenna panel using a second transmit power that is based on the second closed loop transmit power factor.

In some embodiments of the method 500, the first stored closed loop transmit power factor corresponds to a first closed loop index for the first antenna panel, and the second stored closed loop transmit power factor corresponds to a second closed loop index for the second antenna panel.

In some embodiments of the method 500, the one or more TPC commands comprises a first TPC command corresponding to each of the first antenna panel and the second antenna panel, and the applying the one or more TPC commands to the first stored closed loop transmit power factor and the second stored closed loop transmit power factor comprises applying the first TPC command to each of the first stored closed loop transmit power factor and the second stored closed loop transmit power factor.

In some embodiments of the method 500, the one or more TPC commands comprises a first TPC command corresponding to the first antenna panel and a second TPC command corresponding to the second antenna panel and the applying the one or more TPC commands to the first stored closed loop transmit power factor and the second stored closed loop transmit power factor comprises applying the first TPC command to the first stored closed loop transmit power factor and applying the second TPC command to the second stored closed loop transmit power factor. In some such embodiments, each of the first TPC command and the second TPC command are represented with two bits.

In some embodiments of the method 500, each of the first transmit power and the second transmit power are further based on a scaling percentage determined with respect to a maximum transmit power for the UE.

In some embodiments of the method 500, each of the first transmit power and the second transmit power are further based on a scaling amount determined with respect to a maximum transmit power for the UE.

In some embodiments of the method 500, the first transmit power is further based on a scaling determined with respect to a maximum transmit power for the UE and the second transmit power.

In some embodiments of the method 500, the first transmit power is further based on a first scaling percentage determined with respect to a maximum transmit power for the UE, and the second transmit power is further based on a second scaling percentage determined with respect to a maximum transmit power for the UE and the first scaling percentage.

In some embodiments of the method 500, the one or more TPC commands is received from the network in the first DCI.

In some embodiments of the method 500, the one or more TPC commands is received from the network in a second DCI. In some such embodiments, the one or more TPC commands comprises two TPC commands, and the second DCI does not comprise a closed loop indicator field.

FIG. 6 illustrates a method 600 of a RAN, according to embodiments herein. The method 600 includes sending 602, to a UE having a first antenna panel and a second antenna panel, a first DCI scheduling a first PUSCH on the first antenna panel and a second PUSCH on the second antenna panel that is simultaneous with the first PUSCH. The method 600 further includes sending 604, to the UE, a first TPC command corresponding to the first antenna panel and a second TPC command corresponding to the second antenna panel. The method 600 further includes simultaneously receiving 606, from the UE, the first PUSCH on a first TRP of the RAN and a second PUSCH on a second TRP of the RAN.

In some embodiments of the method 600, each of the first TPC command and the second TPC command are represented with two bits.

In some embodiments of the method 600, the first TPC command and the second TPC command are sent to the UE in the first DCI.

In some embodiments of the method 600, the first TPC command and the second TPC command are sent to the UE in a second DCI. In some such embodiments, the second DCI does not comprise a closed loop indicator field.

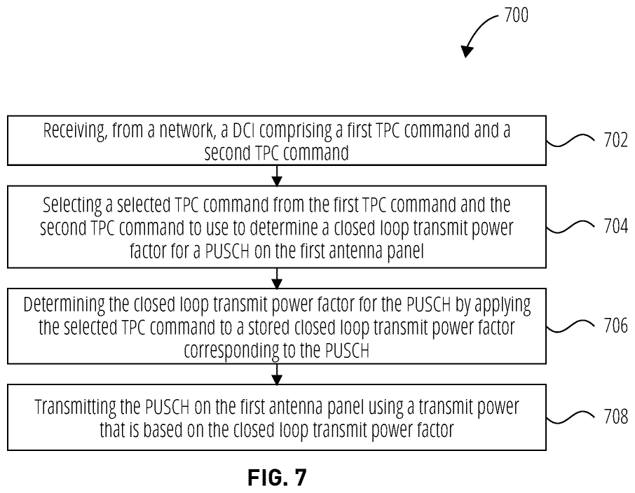

FIG. 7 illustrates a method 700 of a UE having a first antenna panel and a second antenna panel, according to embodiments herein. The method 700 includes receiving 702, from a network, a DCI comprising a first TPC command and a second TPC command. The method 700 further includes selecting 704 a selected TPC command from the first TPC command and the second TPC command to use to determine a closed loop transmit power factor for a PUSCH on the first antenna panel. The method 700 further includes determining 706 the closed loop transmit power factor for the PUSCH by applying the selected TPC command to a stored closed loop transmit power factor corresponding to the PUSCH. The method 700 further includes transmitting 708 the PUSCH on the first antenna panel using a transmit power that is based on the closed loop transmit power factor.

In some embodiments of the method 700, the selected TPC command is selected based on a correspondence of the selected TPC command to the first antenna panel.

In some embodiments of the method 700, the selected TPC command is the first-ordered TPC command of the first TPC command and the second TPC command in the DCI.

In some embodiments of the method 700, each of the first TPC command and the second TPC command are represented in the DCI with two bits.

In some embodiments of the method 700, the DCI schedules the PUSCH on the first antenna panel.

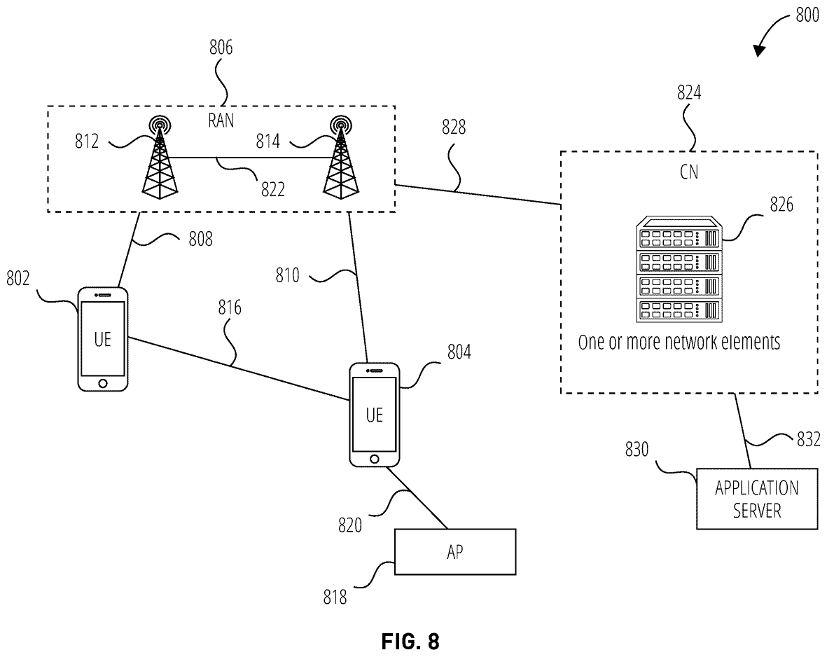

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as base station 812 and base station 814) that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

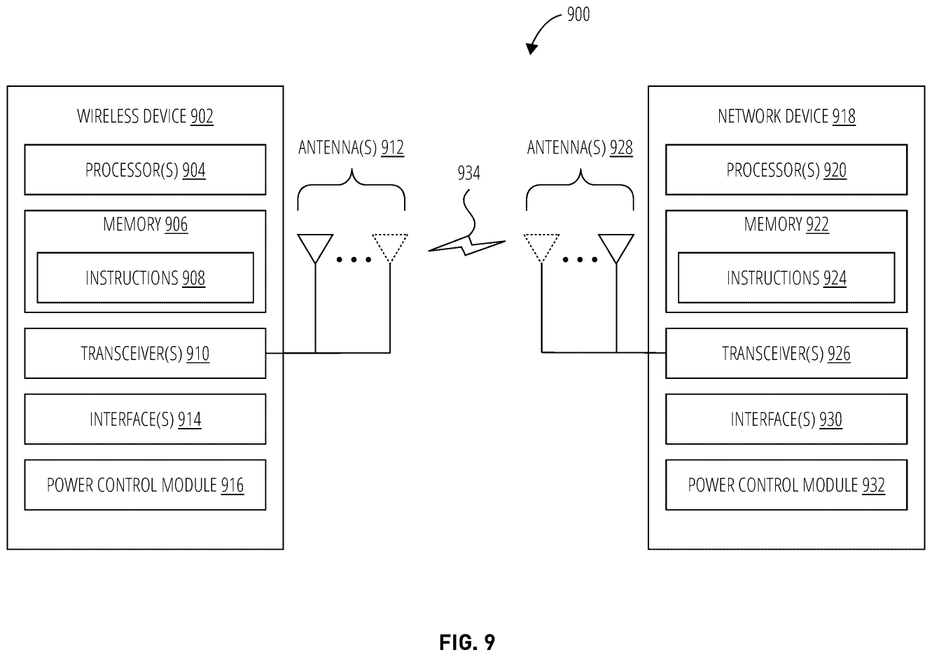

FIG. 9 illustrates a system 900 for performing signaling 934 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter circuitry and/or receiver circuitry that use the antenna(s) 912 of the wireless device 902 to facilitate signaling (e.g., the signaling 934) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include a power control module 916. The power control module 916 may be implemented via hardware, software, or combinations thereof. For example, the power control module 916 may be implemented as a processor, circuit, and/or instructions 908 stored in the memory 906 and executed by the processor(s) 904. In some examples, the power control module 916 may be integrated within the processor(s) 904 and/or the transceiver(s) 910. For example, the power control module 916 may be implemented by a combination of software components (e.g., executed by a DSP or a general processor) and hardware components (e.g., logic gates and circuitry) within the processor(s) 904 or the transceiver(s) 910.

The power control module 916 may be used for various aspects of the present disclosure, for example, aspects of FIG. 1 through FIG. 7. The power control module 916 may be configured to, for example, use one or more SRIs with one or more SRI-indexed power control lists to determine open loop transmit power factors for simultaneous PUSCHs on respective antenna panels as scheduled by a DCI, use one or more TPC commands with one or more store closed loop transmit power factors to determine closed loop transmit power factors for simultaneous PUSCHs on respective antenna panels as scheduled by a DCI, use DPS to apply one of two SRIs or TPCs to a PUSCH transmission, and/or perform scaling of simultaneous PUSCHs on respective antenna panels, in the manner that is discussed herein.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter circuitry and/or receiver circuitry that use the antenna(s) 928 of the network device 918 to facilitate signaling (e.g., the signaling 934) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 918 may include a power control module 932. The power control module 932 may be implemented via hardware, software, or combinations thereof. For example, the power control module 932 may be implemented as a processor, circuit, and/or instructions 924 stored in the memory 922 and executed by the processor(s) 920. In some examples, the power control module 932 may be integrated within the processor(s) 920 and/or the transceiver(s) 926. For example, the power control module 932 may be implemented by a combination of software components (e.g., executed by a DSP or a general processor) and hardware components (e.g., logic gates and circuitry) within the processor(s) 920 or the transceiver(s) 926.

The power control module 932 may be used for various aspects of the present disclosure, for example, aspects of FIG. 1 through FIG. 7. The power control module 932 may be configured to, for example, provide scheduling DCI scheduling simultaneous PUSCHs on respective antenna panels, provide two SRIs along with one or more SRI-indexed power control lists to a UE, provide two TPC commands to a UE, send DPS signaling to a UE, in the manner that is discussed herein.

Embodiments contemplated herein include an apparatus comprising means to perform one or more elements of any of the method 200, the method 400, the method 500, and/or the method 700. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 200, the method 400, the method 500, and/or the method 700. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of any of the method 200, the method 400, the method 500, and/or the method 700. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 200, the method 400, the method 500, and/or the method 700. This apparatus may be, for example, an apparatus of a UE (such as a wireless device 902 that is a UE, as described herein).

Embodiments contemplated herein include a signal as described in or related to one or more elements of any of the method 200, the method 400, the method 500, and/or the method 700.

Embodiments contemplated herein include a computer program or computer program product comprising instructions, wherein execution of the program by a processor is to cause the processor to carry out one or more elements of any of the method 200, the method 400, the method 500, and/or the method 700. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

Embodiments contemplated herein include an apparatus comprising means to perform one or more elements of any of the method 300 and/or the method 600. This apparatus may be, for example, an apparatus of a base station (such as a network device 918 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 300 and/or the method 600. This non-transitory computer-readable media may be, for example, a memory of a base station (such as a memory 922 of a network device 918 that is a base station, as described herein).

Embodiments contemplated herein include an apparatus comprising logic, modules, or circuitry to perform one or more elements of any of the method 300 and/or the method 600. This apparatus may be, for example, an apparatus of a base station (such as a network device 918 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 300 and/or the method 600. This apparatus may be, for example, an apparatus of a base station (such as a network device 918 that is a base station, as described herein).

Embodiments contemplated herein include a signal as described in or related to one or more elements of any of the method 300 and/or the method 600.

Embodiments contemplated herein include a computer program or computer program product comprising instructions, wherein execution of the program by a processing element is to cause the processing element to carry out one or more elements of any of the method 300 and/or the method 600. The processor may be a processor of a base station (such as a processor(s) 920 of a network device 918 that is a base station, as described herein). These instructions may be, for example, located in the processor and/or on a memory of the base station (such as a memory 922 of a network device 918 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE) having a first antenna panel and a second antenna panel, comprising:
receiving, from a network, a first downlink control information (DCI) scheduling a first physical uplink shared channel (PUSCH) on the first antenna panel and a second PUSCH on the second antenna panel that is simultaneous with the first PUSCH;
receiving, from the network, one or more transmit power control (TPC) commands;
determining a first closed loop transmit power factor for the first PUSCH and a second closed loop transmit power factor for the second PUSCH by applying the one or more TPC commands to a first stored closed loop transmit power factor corresponding to the first antenna panel and a second stored closed loop transmit power factor corresponding to the second antenna panel; and
simultaneously transmitting, to the network, the first PUSCH on the first antenna panel using a first transmit power that is based on the first closed loop transmit power factor and the second PUSCH on the second antenna panel using a second transmit power that is based on the second closed loop transmit power factor.

2. The method of claim 1, wherein the first stored closed loop transmit power factor corresponds to a first closed loop index for the first antenna panel, and wherein the second stored closed loop transmit power factor corresponds to a second closed loop index for the second antenna panel.

3. The method of claim 1, wherein:
the one or more TPC commands comprises a first TPC command corresponding to each of the first antenna panel and the second antenna panel;
the applying the one or more TPC commands to the first stored closed loop transmit power factor and the second stored closed loop transmit power factor comprises applying the first TPC command to each of the first stored closed loop transmit power factor and the second stored closed loop transmit power factor.

4. The method of claim 1, wherein:
the one or more TPC commands comprises a first TPC command corresponding to the first antenna panel and a second TPC command corresponding to the second antenna panel;
the applying the one or more TPC commands to the first stored closed loop transmit power factor and the second stored closed loop transmit power factor comprises applying the first TPC command to the first stored closed loop transmit power factor and applying the second TPC command to the second stored closed loop transmit power factor.

5. The method of claim 4, wherein each of the first TPC command and the second TPC command are represented with two bits.

6. The method of claim 1, wherein each of the first transmit power and the second transmit power are further based on a scaling percentage determined with respect to a maximum transmit power for the UE.

7. The method of claim 1, wherein each of the first transmit power and the second transmit power are further based on a scaling amount determined with respect to a maximum transmit power for the UE.

8. The method of claim 1, wherein the first transmit power is further based on a scaling determined with respect to a maximum transmit power for the UE and the second transmit power.

9. The method of claim 1, wherein:
the first transmit power is further based on a first scaling percentage determined with respect to a maximum transmit power for the UE; and
the second transmit power is further based on a second scaling percentage determined with respect to a maximum transmit power for the UE and the first scaling percentage.

10. The method of claim 1, wherein the one or more TPC commands is received from the network in the first DCI.

11. The method of claim 1, wherein the one or more TPC commands is received from the network in a second DCI.

12. The method of claim 11, wherein:
the one or more TPC commands comprises two TPC commands; and
the second DCI does not comprise a closed loop indicator field.

13. A method of a radio access network (RAN), comprising:
sending, to a user equipment (UE) having a first antenna panel and a second antenna panel, a first downlink control information (DCI) scheduling a first physical uplink shared channel (PUSCH) on the first antenna panel and a second PUSCH on the second antenna panel that is simultaneous with the first PUSCH;
sending, to the UE, a first TPC command corresponding to the first antenna panel and a second TPC command corresponding to the second antenna panel; and
simultaneously receiving, from the UE, the first PUSCH on a first transmission reception point (TRP) of the RAN and a second PUSCH on a second TRP of the RAN.

14. The method of claim 13, wherein each of the first TPC command and the second TPC command are represented with two bits.

15. The method of claim 13, wherein the first TPC command and the second TPC command are sent to the UE in the first DCI.

16. The method of claim 13, wherein the first TPC command and the second TPC command are sent to the UE in a second DCI.

17. The method of claim 16, wherein the second DCI does not comprise a closed loop indicator field.

18. A method of a user equipment (UE) having a first antenna panel and a second antenna panel, comprising:
receiving, from a network, a downlink control information (DCI) comprising a first transmit power control (TPC) command and a second TPC command;
selecting a selected TPC command from the first TPC command and the second TPC command to use to determine a closed loop transmit power factor for a physical uplink shared channel (PUSCH) on the first antenna panel;
determining the closed loop transmit power factor for the PUSCH by applying the selected TPC command to a stored closed loop transmit power factor corresponding to the PUSCH; and
transmitting the PUSCH on the first antenna panel using a transmit power that is based on the closed loop transmit power factor.

19. The method of claim 18, wherein the selected TPC command is selected based on a correspondence of the selected TPC command to the first antenna panel.

20. The method of claim 18, wherein the selected TPC command is the first-ordered TPC command of the first TPC command and the second TPC command in the DCI.

21-26. (canceled)
